(19) United States
(12) Patent Application Publication
(10) Pub. No.: US 2023/0393966 A1
(43) Pub. Date: Dec. 7, 2023

(54) SOFTWARE RELEASING METHOD AND APPARATUS, COMPUTING DEVICE AND STORAGE MEDIUM

(71) Applicant: BEIJING TUSEN ZHITU TECHNOLOGY CO., LTD., Beijing (CN)

(72) Inventor: Qingyu SUI, Beijing (CN)

(21) Appl. No.: 18/202,473

(22) Filed: May 26, 2023

(30) Foreign Application Priority Data
Jun. 2, 2022 (CN) 202210624499.8

(51) Int. Cl. G06F 11/36

(52) U.S. Cl. CPC G06F 11/3688

(57) ABSTRACT

The present application relates to a software releasing method and apparatus, a computing device and a storage medium. The software releasing method comprises: acquiring a software identifier contained in a software combination; in each first period, selecting a target software for each software identifier from a plurality of candidate software that have passed a functional test to generate a first software group which is to be subjected to an integration test in a computing device; in each second period, selecting at least one software group from a plurality of said first software groups that have passed the integration test in the corresponding period as a second software group which is to be subjected to an integration test of a next second period in the computing device; and in each second period, taking the second software group that has passed the integration test as the software combination to be released.

The present disclosure claims priority to Chinese patent application No. 202210624499.8, titled “SOFTWARE DEVELOPMENT METHOD AND APPARATUS, COMPUTING DEVICE AND STORAGE MEDIUM”, filed on Jun. 2, 2022, the content of which is incorporated herein by reference in its entirety.

### TECHNICAL FIELD

The present application relates to the technical field of computers, and in particular to a software releasing method and apparatus, a computing device and a storage medium.

### BACKGROUND

The software test for autonomous driving differs too much from the traditional software test mainly in that the effectiveness of the autonomous driving software requires long duration tests on real vehicles to ensure. However, vehicles, particularly autonomous trucks, are not as readily available as a cluster of servers due to their high cost, the cost of associated safety officers and testing personnel as well as the associated restrictions of legal regulations. Therefore, in the case that the test resources are greatly limited, how to more effectively utilize the test resources to realize the development test of the autonomous driving software becomes an important topic.

### SUMMARY

The present application provides a software releasing (i.e. software development) method and apparatus, a computing device, a storage medium and a vehicle, so as to solve the problem that autonomous driving software cannot be efficiently tested due to limited test resources.

An aspect of the embodiments of the present application provides a software releasing (i.e. software development) method, which comprises: acquiring a software identifier contained in a software combination to be released; in each first period, selecting a target software for each software identifier from a plurality pieces of software that have passed a functional test in the corresponding period to generate a first software group, the first software group to be subjected to an integration test in a computing device; in each second period, selecting at least one software group from a plurality of said first software groups that have passed the integration test in the corresponding period as a second software group, the second software group to be subjected to an integration test of a next second period in the computing device; and in each second period, taking the second software group that has passed the integration test in the corresponding period as the software combination to be released, or selecting at least one software group from the second software groups that have passed the integration test as the software combination to be released.

Another aspect of the embodiments of the present application provides a computing device comprising one or more processors, and a memory having one or more programs stored thereon, wherein the one or more programs, when executed by the one or more processors, cause the computing device to implement the software releasing (i.e. software development) method according to the present application.

Yet another aspect of the embodiments of the present application provides a computer-readable storage medium having a program stored thereon, wherein the program, when executed by a processor, causes the computing device to implement the software releasing (i.e. software development) method according to the present application.

According to the technical solution of the present application, the software that has passed the functional test currently is determined in each first period, and a first software group is generated according to the software identifier of the software group to be released, so that a plurality of first software groups may be generated in a plurality of continuous first periods. Each of the first software groups may be subjected to an integration test in the computing device such that a plurality of first software groups may participate in the integration test in each second period. One of the software groups that have passed the integration test is selected as a second software group, and the second software group will be subjected to an integration test in a next second period. After each second period is completed, the second software group that has passed the integration test may be used as the software group to be released. Therefore, an iterative update of the software version can be achieved quickly and efficiently in the case that test resources such as vehicles are limited.

### BRIEF DESCRIPTION OF THE DRAWINGS

In order to more clearly illustrate the embodiments of the present invention or technical solutions in the prior art, the drawings used in the description of the embodiments or prior art will be briefly described below. It is apparent that other drawings can be derived from these drawings by those of ordinary skill in the art without making creative efforts.

FIG. 1 shows a schematic diagram of a vehicle 100 according to an embodiment of the present application;

FIG. 2 shows a flowchart of a software releasing method 200 according to an embodiment of the present application;

FIG. 3 shows a flowchart of a software releasing method 300 according to an embodiment of the present application;

FIG. 4 shows a schematic diagram of a software releasing method according to an embodiment of the present application; and

FIG. 5 shows a structural diagram of a computing device 500 according to an embodiment of the present application.

### DETAILED DESCRIPTION

The technical solutions in the embodiments of the present application will be clearly and completely described below with reference to the accompanying drawings. It is obvious that the described embodiments are only part of the embodiments of the present invention rather than all of the embodiments. Based on the embodiments in the present specification, various variations and modifications can be made by those of ordinary skill in the art, and all technical solutions obtained by equivalent modifications shall fall within the protection scope of the present invention.

To facilitate a clear description of the technical solutions of the embodiments of the present application, in the embodiments of the present application, the terms “first”, “second”, etc., are used to distinguish the same items or similar items with basically the same functions or actions, and those skilled in the art will appreciate that the terms “first”, “second”, etc., are not intended to limit the quantity and execution order.

The term “and/or” used herein is merely an associative relationship describing associated objects, and refers to that there may be three relationships, for example, A and/or B, may refers to that: A is present alone, A and B are present simultaneously, and B is present alone. In addition, the character “/” used herein generally indicates an “or” relationship between the associated objects.

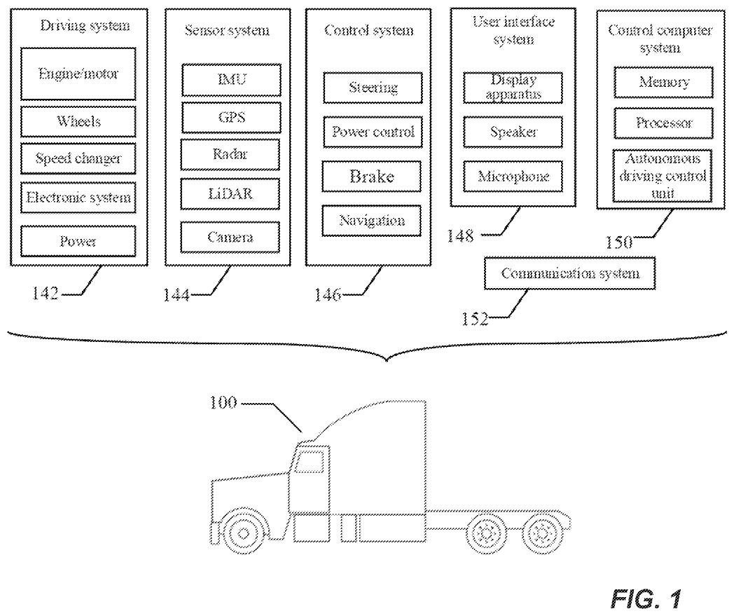

FIG. 1 is a schematic diagram of a vehicle 100 in which various techniques of the present application are implemented. The vehicle 100 may be a car, a truck, a motorcycle, a bus, a watercraft, an airplane, a helicopter, a hay mower, an excavator, a snowmobile, an aircraft, a recreational vehicle, an amusement park vehicle, a farm apparatus, a construction apparatus, a tram, a golf cart, a train, a trolley bus or other vehicles. The vehicle 100 can be operated fully or partially in an autonomous driving mode. The vehicle 100 can control itself in the autonomous driving mode. For example, the vehicle 100 can determine a current state of the vehicle and a current state of an environment in which the vehicle is located, determine a predicted behavior of at least one other vehicle in this environment, and determine a trust level corresponding to a likelihood that the at least one other vehicle performs the predicted behavior, and thus the vehicle 100 can control itself based on the determined information. The vehicle 100, when in the autonomous driving mode, can be operated without human interaction.

The vehicle 100 may comprise various vehicle systems, such as a driving system 142, a sensor system 144, a control system 146, a user interface system 148, a control computer system 150 and a communication system 152. The vehicle 100 may comprise more or fewer systems, each of which may comprise a plurality of units. Further, each system and unit of the vehicle 100 can be interconnected. For example, the control computer system 150 can be in data communication with one or more of the systems 142-148, and 152. Thus, one or more of the described functions of the vehicle 100 may be divided into additional functional or physical components or combined into a fewer number of functional or physical components. In a still further example, additional functional or physical components may be added to the example shown in FIG. 1.

The driving system 142 may comprise a plurality of operable components (or units) that provide kinetic energy for the vehicle 100. In one embodiment, the driving system 142 may comprise an engine or a motor, wheels, a speed changer, an electronic system, and power (or a source of power). The engine or motor may be any combination of the following apparatuses: an internal combustion engine, an electrical machine, a steam engine, a fuel cell engine, a propane engine or other forms of engines or motors. In some embodiments, the engine may convert a source of power into mechanical energy. In some embodiments, the driving system 142 may comprise a variety of engines or motors. For example, a hybrid electric vehicle may comprise a gasoline engine and a motor, and may also comprise other combinations.

The wheels of the vehicle 100 may be standard wheels. The wheels of the vehicle 100 may be in a variety of forms including single wheel, dual wheel, three wheel or four wheel forms, such as four wheels on a car or a truck. Other numbers of wheels are possible, such as six or more wheels. One or more wheels of the vehicle 100 may be operated to rotate in a direction different from the other wheels. The wheel may be at least one wheel fixedly connected with the speed changer. The wheel may comprise a combination of metal and rubber or a combination of other substances. The speed changer may comprise a unit operable to transmit mechanical power of the engine to the wheels. For this purpose, the speed changer may comprise a gearbox, a clutch, a differential gear and a propeller shaft. The speed changer may also comprise other units. The propeller shaft may comprise one or more axles that match with the wheels. The electronic system may comprise a unit for transmitting or controlling electronic signals of the vehicle 100. These electronic signals can be used to activate a plurality of lights, servos, motors and other electronically driven or controlled apparatuses in the vehicle 100. The source of power may be an energy source that wholly or partially powers an engine or a motor. That is, the engine or the motor can convert the source of power into mechanical energy. For example, the source of power may comprise gasoline, petroleum, petroleum-based fuels, propane, other compressed gas fuels, ethanol, fuel cells, solar panels, batteries and other sources of electrical energy. The source of power may additionally or optionally comprise any combination of a fuel tank, a battery, a capacitor or a flywheel. The source of power may also provide power to other systems of the vehicle 100.

The sensor system 144 may comprise a plurality of sensors for sensing information about the environment and conditions of the vehicle 100. For example, the sensor system 144 may comprise an inertial measurement unit (IMU), a global positioning system (GPS) transceiver, a radar (RADAR) unit, a laser rangefinder/LiDAR unit (or other distance measurement apparatus), an acoustic sensor, and a camera or image capture apparatus. The sensor system 144 may comprise a plurality of sensors (e.g., oxygen (02) monitors, fuel gauge sensors, and engine oil pressure sensors) configured for monitoring the vehicle 100. The sensor system 144 may also be equipped with other sensors. One or more sensors comprised in the sensor system 144 can be driven individually or collectively to update the location, orientation, or both of the one or more sensors.

In some embodiments, each sensor acquires data through a hardware trigger or a software trigger, with different sensors having different trigger frequencies, i.e., different data acquisition frequencies, and correspondingly having different data acquisition periods. For the hardware trigger, a trigger source uses a pulse per second signal sent by Novatel as a trigger source signal, and adjusts the trigger source signal according to trigger frequencies required by different sensors to generate a trigger signal and send the trigger signal to a corresponding sensor so as to trigger the corresponding sensor to acquire data. Optionally, the trigger frequency of the camera is 20 HZ, the trigger frequency of the LiDAR is 1 HZ or 10 HZ, and the trigger frequency of the IMU is 100 HZ, but it is certainly not limited to this.

The IMU may comprise a combination of sensors (e.g., an accelerometer and a gyroscope) for sensing location and direction changes of the vehicle 100 based on inertial acceleration. The GPS transceiver may be any sensor for estimating the geographic location of the vehicle 100. For this purpose, the GPS transceiver may comprise a receiver/a transmitter to provide location information of the vehicle 100 relative to the earth. It should be noted that GPS is an example of a global navigation satellite system, and therefore, in some embodiments, the GPS transceiver may be replaced with a BeiDou satellite navigation system transceiver or a Galileo satellite navigation system transceiver. The radar unit may use radio signals to sense an object in the environment in which the vehicle 100 is located. In some embodiments, in addition to sensing the object, the radar unit may also be configured for sensing the speed and heading of an object approaching the vehicle 100. The laser rangefinder or LiDAR unit (or other distance measurement apparatuses) may be any sensor that uses laser light to sense an object in the environment in which the vehicle 100 is located. In one embodiment, the laser rangefinder/LiDAR unit may comprise a laser source, a laser scanner, and a detector. The laser rangefinder/LiDAR unit is configured for operating in either a consecutive (e.g., using heterodyne detection) or inconsecutive detection mode. The camera may comprise an apparatus for capturing a plurality of images of the environment in which the vehicle 100 is located. The camera may be a still image camera or a dynamic video camera.

The control system 146 is configured for controlling the operation of the vehicle 100 and components (or units) thereof. Accordingly, the control system 146 may comprise various units, such as a steering unit, a power control unit, a brake unit, and a navigation unit.

The steering unit may be a combination of machines that adjust the heading of the vehicle 100. The power control unit (which may be, e.g., an accelerator) may be, for example, configured for controlling the operating speed of the engine and thereby the speed of the vehicle 100. The brake unit may comprise a combination of machines for decelerating the vehicle 100. The brake unit may use friction to decelerate the vehicle in a standard manner. In other embodiments, the brake unit may convert kinetic energy of the wheel into electric current. The brake unit may be in other forms as well. The navigation unit may be any system that determines a driving path or route for the vehicle 100. The navigation unit may also dynamically update the driving path as the vehicle 100 proceeds. The control system 146 may additionally or optionally comprise other components (or units) not shown or described.

The user interface system 148 can be configured to allow the interaction between the vehicle 100 and external sensors, other vehicles, other computer systems, and/or users of the vehicle 100. For example, the user interface system 148 may comprise a standard visual display apparatus (e.g., a plasma display, a Liquid Crystal Display (LCD), a touch screen display, a head-mounted display, or other similar displays), a speaker or other audio output apparatuses, a microphone, or other audio input apparatuses. For example, the user interface system 148 may also comprise a navigation interface and an interface to control the internal environment (e.g., temperature or fans) of the vehicle 100.

The communication system 152 may provide the vehicle 100 with a way to communicate with one or more devices or other vehicles in the vicinity. In one exemplary embodiment, the communication system 152 may communicate with one or more devices directly or through a communication network. The communication system 152 may be, for example, a wireless communication system. For example, the communication system may use 3G cellular communication (e.g., CDMA, EVDO or GSM/GPRS) or 4G cellular communication (e.g., WiMAX or LTE), and may also use 5G cellular communication. Optionally, the communication system may communicate with a Wireless Local Area Network (WLAN) (e.g., using WIFI®). In some embodiments, the communication system 152 may communicate directly with one or more devices or other vehicles around, for example, using infrared, Bluetooth® or ZIGBEE. Other wireless protocols, such as various vehicle-mounted communication systems, are also within the scope of the present application. For example, the communication systems may comprise one or more Dedicated Short Range Communication (DSRC) apparatuses, V2V apparatuses or V2X apparatuses that may be in data communication publicly or privately with vehicles and/or roadside stations.

The control computer system 150 can control some or all of the functions of the vehicle 100. An autonomous driving control unit of the control computer system 150 can be configured to identify, evaluate and avoid or eliminate potential obstacles in the environment in which the vehicle 100 is located. In general, the autonomous driving control unit can be configured to control the vehicle 100 in the absence of a driver or to provide assistance to the driver in controlling the vehicle. In some embodiments, the autonomous driving control unit is configured to combine data from a GPS transceiver, a radar, a LiDAR, a camera and other vehicle systems to determine a travel path or trajectory of the vehicle 100. The autonomous driving control unit can be activated to enable the vehicle 100 to be driven in an autonomous driving mode.

The control computer system 150 may comprise at least one processor (which may comprise at least one microprocessor) that executes processing instructions (i.e., machine-executable instructions) stored in a non-volatile computer readable medium (e.g., a data storage apparatus or a memory). The memory stores therein at least one machine-executable instruction. The processor executes the at least one machine-executable instruction to implement functions of the map engine, the positioning module, the sensing module, the navigation or routing module, the automatic control module, and the like. The map engine and the positioning module are configured for providing map information and positioning information. The sensing module is configured for sensing, according to the information acquired by the sensor system and the map information provided by the map engine, things in the environment where the vehicle is located. The navigation or routing module is configured for planning a travel path for the vehicle according to the processing results of the map engine, the positioning module, and the sensing module. The automatic control module inputs, analyzes and converts decision information of the module such as the navigation or routing module into a control command for a vehicle control system, outputs the control command, and sends the control command to a corresponding component in the vehicle control system through a vehicle-mounted network (for example, an in-vehicle electronic network system which is achieved through a controller area network (CAN) bus, a local area Internet, a multimedia directional system, and the like), so as to achieve automatic control for the vehicle. The automatic control module can also acquire information of all components in the vehicle through the vehicle-mounted network.

The control computer system 150 may also be a plurality of computing apparatuses that distributively control components or systems of the vehicle 100. In some embodiments, the memory may contain processing instructions (e.g., program logic) that are executed by the processor to implement various functions of the vehicle 100. In one embodiment, the control computer system 150 can be in data communication with the systems 142, 144, 146, 148, and/or 152. The interfaces of the control computer system are configured to facilitate data communication between the control computer system 150 and the systems 142, 144, 146, 148, and 152.

The memory may also comprise other instructions, including instructions for data transmission, data reception, interaction, or control of the driving system 142, the sensor system 144, the control system 146 or the user interface system 148.

In addition to storing processing instructions, the memory may store a variety of information or data, such as image processing parameters, road maps and path information. The information may be used by the vehicle 100 and the control computer system 150 during operation of the vehicle 100 in an autonomous mode, a semi-autonomous mode and/or a manual mode.

Although the autonomous driving control unit is shown as separated from the processor and the memory, it should be understood that, in some embodiments, some or all of the functions of the autonomous driving control unit can be implemented using program code instructions residing in one or more memories (or data storage apparatuses) and can be executed by the one or more processors, and that the autonomous driving control unit can be implemented using the same processor and/or memory (or data storage apparatus) in some cases. In some embodiments, the autonomous driving control unit may be implemented, at least in part, using various application-specific circuit logics, various processors, various Field Programmable Gate Arrays (FPGAs), various Application-Specific Integrated Circuits (ASICs), various real-time controllers and hardware.

The control computer system 150 may control functions of the vehicle 100 based on inputs received from various vehicle systems (e.g., the driving system 142, the sensor system 144 and the control system 146) or inputs received from the user interface system 148. For example, the control computer system 150 may use inputs from the control system 146 to control the steering unit to avoid obstacles detected by the sensor system 144. In one embodiment, the control computer system 150 may be configured to control various aspects of the vehicle 100 and systems thereof.

Although various components (or units) integrated into the vehicle 100 are shown in FIG. 1, one or more of the components (or units) may be mounted on the vehicle 100 or separately associated with the vehicle 100. For example, the control computer system may exist partially or wholly independent of the vehicle 100. Thus, the vehicle 100 can exist in the form of separated or integrated device units. The device units constituting the vehicle 105 can communicate with each other in wired or wireless communication. In some embodiments, additional components or units may be added to various systems, or one or more components or units above (e.g., the LiDAR or radar as shown in FIG. 1) may be removed from the systems.

One of the main purposes of the present application is to perform software releasing tests, and different developers can develop different pieces of software which comprise at least one of: container files, binary software packages, and compressed packages with file names, etc. After a builder packs a plurality pieces of software into a software combination (or a software group for short), the software group is tested. The software may be autonomous driving software, and the corresponding software group is an autonomous driving software group. For convenience, it should be understood that the autonomous driving software, different from the traditional PC-end software and mobile-end software, needs to complete the test in the running process of the actual vehicle. However, when the vehicle resource of the autonomous vehicle is limited, the test road section is limited, and the test mileage is limited, an efficient iteration update solution for autonomous driving software needs to be provided.

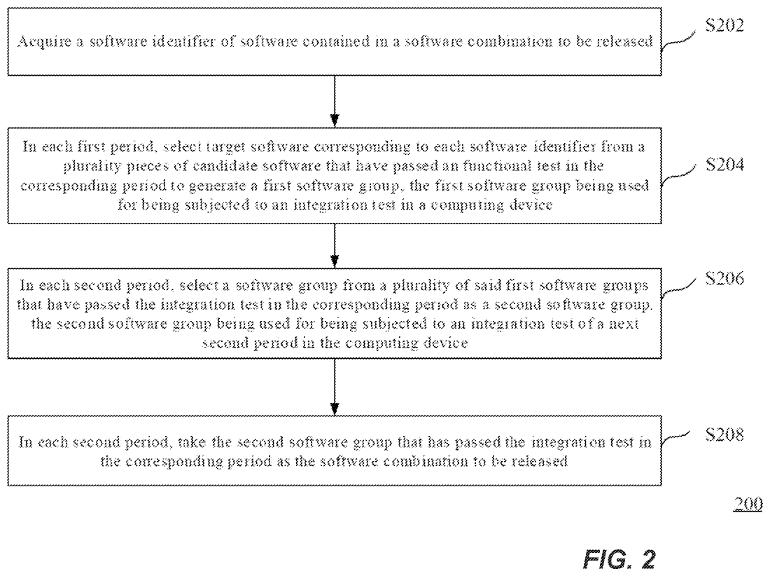

FIG. 2 is a flowchart of a software releasing method 200 according to an embodiment of the present application. As shown in FIG. 2, the method 200 comprises:

Step S202, acquiring a software identifier for each software contained in a software combination to be released;

Step S204, in each first period, selecting a target software for each software identifier from a plurality of candidate software that have passed a functional test in the corresponding period to generate a first software group, the first software group to be subjected to an integration test in a computing device;

Step S206, in each second period, selecting at least one software group from a plurality of said first software groups that have passed the integration test in the corresponding period as a second software group, the second software group to be subjected to an integration test of a next second period in the computing device; and

Step S208, in each second period, taking the second software group that has passed the integration test in the corresponding period as the software combination to be released.

According to an embodiment, in step S202, before the first test for development, the software identifier required to be contained in the first version of software combination to be released may be preliminarily determined according to the requirement of a developer. Then, in the iterative process of the software combination, which pieces of software need to be newly added in the software combination having the current version and the software identifier of the newly added software may be determined according to the test requirements of a developer, so as to obtain the software identifier contained in the next software combination to be released.

According to an embodiment, in step S202, in terms of file types of software, the candidate software may comprise at least one of: container files, binary software packages, and compressed packages with file names. In terms of software attributes, the candidate software may comprise at least one of: formal version software and test version software; if the software is provided with formal version software, the latest software is a formal version of the software; if the software is only provided with test version software, the latest software is a latest test version of the software. Each piece of software may be provided with a version number, the newer the version number is, the newer the software is represented. The test version software and the formal version software are respectively provided with corresponding software labels. For example, the version number of the test version software is provided with special characters, etc., so that the formal version software and the latest test version software may be selected according to the software version number. The autonomous driving software running on the vehicle may be one or more Docker images, a software package of a binary software package management tool, a compressed package with a file name, or any similar distribution means and any combination thereof, as long as two different sets of autonomous driving software can be distinguished in any way.

For example, according to the test requirements, a software combination needs to be generated for testing based on software 1, software 2, software 3 and software 4, wherein software 1 and software 2 may be container files, software 3 may be a binary software package, software 4 may be a compressed package with a file name, and any plurality pieces of software of the same or different types may generate a software combination as long as each piece of software has its own unique software identifier and software name, so that different pieces of software can be distinguished. If software 1 and software 2 are provided with formal version software, the corresponding formal versions of the software are selected respectively, and if software 1 and software 2 are provided with a plurality of formal versions respectively, the latest formal versions are selected respectively. If software 3 and software 4 are only provide with test version software, the latest test versions are selected respectively.

According to an embodiment, before those pieces of software selected each time are used to generate a software combination, the software that has passed the functional test currently is determined as the candidate software, namely, those pieces of software used for generating the software combination have passed the functional test. The functional test is used for testing whether one piece of software is normal. The software to be tested can be generally updated into the software combination having the current stable version, and as long as the updated software passes the integration test in the computing device, it represents that the software to be tested passes the functional test. The integration test is used for testing whether one software combination is normal. The software combination having the stable version represents that all pieces of software therein are normal, and those pieces of software are normal in mutual coordination, so that whether the updated software is normal can be determined by comparing test results before and after updating the software.

The functional test and the integration test may be performed on a traveling autonomous vehicle, namely, the generated software combination is sent to the computing device of the autonomous vehicle, wherein the software combination may comprise various types of software such as various pieces of positioning algorithm software, perception algorithm software, decision algorithm software, control algorithm software, upper computer software, lower computer software, switch software, etc. Then, the software combination to be tested is run in the traveling process of the autonomous vehicle, and whether the test result is normal is determined according to a preset indicator, so as to determine whether the software combination passes the test. If the software combination passes the test, it is normal, and if the software combination is normal, all pieces of software contained in the software combination are also normal. The preset indicator is a safety stability indicator for autonomous driving, may be set by those skilled in the art as needed, and comprises, for example, at least one of the number of takeovers per kilometer of an autonomous vehicle, the average time interval of two adjacent takeovers, the number of system errors per unit time (for example, per hour), the time occupancy of a high occupancy of system resources, the mean occupancy of the system resources, and a test indicator under a specific road environment.

The functional test and the integration test may also be performed on a virtual simulation platform, namely, the software combination to be tested is sent to the virtual simulation platform, and the vehicle in the virtual simulation platform runs the software combination in the traveling process, so that the test result of the software combination may be obtained.

It should be noted that, in some cases, if none of the software versions corresponding to a certain software identifier passes the functional test, the software may be skipped first, or the latest software version or the software version with the best functional test result may be selected as the temporary software for generating the corresponding software combination. The temporary software being provided with a temporary label (such as a special character in the software name) represents that the software has not passed the functional test.

According to an embodiment, each first period for example comprises: every half day, every m hours, every n days, etc. The duration of the second period is greater than the duration of the first period, further, every second period is larger than every first period, or, at least one second period is larger than at least one first period, for example, the second period comprise every p days, every q weeks, etc. (m, n, p and q are all integers greater than or equal to 1), but it is certainly not limited to this. The reason why a first software group is generated in each first period is that each piece of software may go through a plurality of version updates one by one in the process of continuous iteration updates for the software, so that the latest version of each piece of software is selected in each first period to generate a new first software group. The duration of the first period and the second period may be set by those skilled in the art as needed, which is not limited in the present application. Each first period is equivalent to each first cycle (e.g., every day), and each second period is equivalent to each second cycle (e.g. every two weeks).

Taking the first period as every day and the second period as every two weeks as an example, 1 first software group is generated every day, 7 first software groups are generated every week, and one software group to be released is obtained. Before each generation, according to the software identifier corresponding to the software combination determined in step S202, the latest formal version software or the latest test version software passing the functional test and corresponding to each software identifier is searched, so as to generate a first software combination. Each newly-generated first software group is sent to an autonomous vehicle or the like for an integration test, and the 7 first software groups generated in each second period are subjected to the integration test. The first software group will continuously find new problems in the test process, so that the software codes of a developer are also in the continuous update process, which enables the newly-generated first software group to be also in the continuous update process.

In each second period, a plurality of (e.g., 4) first software groups that have passed the integration test are first determined, and then at least one target software group is finally selected from the plurality of first software groups (e.g., one target software group is selected, such as first software group 7) as the second software group. The second software group is used for being subjected to an integration test in a next second period, and if the second software group passes the integration test in the next period, the second software group is used as the software to be released. If the second software group in the next period fails to pass the integration test, the software to be released temporarily does not exist in the next period, and then the software to be released determined in the previous period is still adopted.

As described above, whether the software groups pass the functional test or the integration test may be determined by means of the preset indicator, which is not described herein again. At least one target software group is selected from the software groups that have passed the integration test. A software group having the optimal test result may be selected, a software group having the latest version may be selected, or a plurality of software groups having the best test results or a plurality of software groups having the latest versions may be selected. The selection may be performed by those skilled in the art as needed, which is not limited in the present disclosure.

According to an embodiment, step S208 further comprises:
Step A1: in each second period, taking the second software group that has passed the integration test in the corresponding period as a third software group, the third software group to be subjected to an integration test of a next second period in the computing device; and
Step A2: selecting a software group having an integration test result meeting a preset indicator from a plurality of said third software groups that have passed the integration test in a plurality of said second periods as the software combination to be released.

Taking the second period as one week as an example, a second software group that has passed the integration test is upgraded to a third software group every week, and the third software group will be subjected to the integration test in the next week. Certainly, the test period of the second software group may also be lengthened or shortened appropriately, and a preset standard is set to determine whether to upgrade the second software group to the third software group. The second software group may be improved to the third software group, for example, by manually verifying the codes. That is, the test period of the second software group may be the same as the test period of the first software group, or may be different from the test period of the first software group, which is not limited in the present disclosure.

A third software group that has passed the integration test and has an integration test result meeting the preset indicator is selected as the software group to be released from the plurality of third software groups which are subjected to the integration test in a plurality of continuous second periods. In an implementation of the present disclosure, no matter the second software group is selected from the first software group, or the software group to be released is selected from the third software group, the selected software group comprises the software group that has passed the integration test and has the latest version, or is the software group that has passed the integration test and has the optical test result. However, as the software iterates, the software group having the latest version is most likely the software group having the optical test result.

In order to distinguish the software groups conveniently, each type of software group of the present disclosure has a corresponding software group label, each software group has a corresponding software group identifier, and the selected software group is the software group that has passed the integration test and has a latest version. The software group labels comprise at least one of a candidate version, a pre-stable version, a stable version and a pre-release version, wherein the first software group is of a candidate version, the second software group is of a pre-stable version, the third software group is of a stable version, and the software group to be released in step B is a pre-release version. Only one software group may be determined based on the software version and software identifier. For example, first software group 1 may be named candidate version 1, second software group 3 may be named pre-stable version 3, third software group 5 may be named stable version 5, and so on.

It should be understood that each of the software groups may inevitably fail to pass the integration test, and at the moment, hotfixes may be performed on these software groups. Thus, the method 200 may further comprises the following steps:
Step B1: determining problematic software groups that have not passed the integration test, from at least one of the first software groups, the second software groups or the third software groups; determining problematic software and normal software of each problematic software group, and updated codes of each piece of problematic software;
Step B2: generating a fourth software group based on the codes of the updated problematic software, and the normal software of the problematic software groups, the fourth software group to be subjected to an integration test in the computing device; and
Step B3: updating, in response to the fourth software group passing the integration test in the computing device, the problematic software groups to/with the fourth software group.

In the steps, the problematic software group is the software group which fails to pass the integration test, which may be any one of the first software group, the second software group, and the third software group. The problematic software of the problematic software group may be determined manually by developers, or the problematic software which is possibly problematic may be recommended by adopting an automatic analysis tool and combining historical problem scenes. Then, updated codes of the problematic software are acquired, and a fourth software group is generated by combining the codes with the original normal software of the problematic software group, wherein the fourth software group may also be referred to as a hotfix software group. If the fourth software group passes the integration test in the computing device, the problematic software group is updated to the fourth software group which is equivalent to a fourth software group without any problems after the updates to the first, second or third software group which has problems originally.

According to an embodiment, a functional test for software comprises the following steps:
Step C1: updating any piece of the software to be tested into a third software group (namely a software group having a stable version) of a current period to obtain a fifth software group, the fifth software group to be subjected to an integration test in the computing device; and
Step C2: determining, in response to the fifth software group passing the integration test in the computing device, that the software to be tested passes the functional test.

Furthermore, on the premise that one or more pieces of software to be tested can be determined to not contradict each other, these pieces of software may be updated to a software group having a stable version in the current period to obtain a fifth software group (which may also be referred to as a functional test software group), and whether these pieces of software are normal is determined according to an integration test result of the fifth software group. If the integration test result is normal, it represents that a plurality pieces of software are normal, otherwise, problematic software in the plurality pieces of software is analyzed.

It can be seen that, in the present disclosure, for the second and third software groups with problems, hotfixes are performed directly on these problematic software groups, while for a certain piece of software to be incorporated into the software group, a real vehicle test is required to verify the validity of a single function, and thus the software is incorporated into the current software group having a stable version for testing. When the software group passes the test, it represents that the software function is normal, and thus the software group may be used for generating the first software group.

In addition, step C1 further comprises:
Step C11: adding, in response to the third software group of the current period not containing legacy version of the software to be tested, the software to be tested into the third software group; and
Step C12: replacing, in response to the third software group of the current period containing legacy version of the software to be tested, the legacy version software with the candidate software to be tested.

For example, assuming that the current third software group is third software group 4 and the software to be tested is software 2, if third software 4 does not contain a software identifier of software 2, software 2 to be tested is newly added into third software group 4. If third software group 4 contains the software identifier of software 2, that is, the third software group already contains legacy version of software 2, the legacy version is replaced with software 2.

As can be seen from the above, in the present disclosure, a plurality types of software groups are generated, such as a plurality of first software groups, second software groups, third software groups, fourth software groups, and fifth software groups, and there may be multiple software groups that need to be subjected to the integration test every day in each second period. The computing device for being subjected to the integration test may comprise a plurality of computing devices disposed on a plurality of vehicles, and a plurality of first software groups, a plurality of second software groups, a plurality of third software groups, a fourth software group, and a fifth software group generated in different periods, as software groups to be tested, are respectively run in the plurality of computing devices of the plurality of vehicles.

The vehicle may comprise an autonomous vehicle, and on the premise that the test resources such as the autonomous vehicles are limited, the test time periods of a plurality of software groups in a plurality of autonomous vehicles and the test vehicles may be planned in advance in the present disclosure. For example, a plurality of test trips of a plurality of vehicles in a preset period are determined, and an associative relationship between the software groups to be tested and the vehicles and the test trips is established to test the associated software group in the test trip of each vehicle. The test trip comprises an outward trip and a return trip, wherein an outward trip and a return trip may be used for testing different software groups and may also be used for testing the same software group. In the present disclosure, whether the same software group is tested in the outward trip and the return trip is determined according to the road condition and the road length of a single trip. For example, if the road condition is complex, or a single trip is long, or the roads for the outward trip and the return trip are the same, different software groups may be tested in the outward trip and the return trip; if the road condition is simple, or the single trip is short, or the roads for the outward trip and the return trip are different, different software groups may be tested in the outward trip and the return trip, but it is certainly not limited to this.

For example, assuming that the types of software groups to be tested on a certain day comprise 4 first software groups, 1 second software group, 1 third software group, 1 fourth software group, and 1 fifth software group, for a total of 7 software groups to be tested, and 5 vehicles are available for testing, wherein each vehicle can be dispatched 3 times, and each outward trip and each return trip are used for testing different software groups, a total test number (5×3×2=30) per day is obtained by means of calculation, and thus 30 tests are allocated according to the total number of the software groups to be tested. On the premise of preferentially testing the second to fifth software groups, the test number of each first software group is increased as much as possible in the present disclosure. If the second to fifth software groups are guaranteed to be tested twice respectively, other tests are performed on each first software group. The construction period of each software group may be adjusted according to actual needs, and the software group can be sent to an autonomous vehicle for testing after being well constructed, or sent to the autonomous vehicle under the unified scheduling of a development and testing device. Generally, a real vehicle test is required to be performed on the latest second software group at least once every day to determine that a problem in the second software group is timely discovered until the second software group is no longer updated and no more real vehicle tests are required. If a second software group or a third software group has serious problems or defects, the problematic software needs to be fixed and subjected to a functional test, and after the codes are manually checked and guaranteed to be correct and no excessive modification is introduced, the problematic software is incorporated back into the corresponding second or third software group.

In addition, each software group to be tested has its own test environment requirements of specific software/hardware, etc., for example, the test requirement of a certain software group comprises that at least 5 cameras should be installed on a vehicle. Therefore, when the software group is matched with the vehicle, it is required to ensure that the vehicle associated with each software group to be tested can meet the test environment requirement of the software group to be tested, so that an optimal matching mode between a plurality of software groups and a plurality of vehicles is realized. Moreover, each software group to be tested may have its own unique road or weather environment requirements, for example, a certain software group needs to be tested at night for testing the night vision function. Therefore, in the present disclosure, each test requirement of each software group and configuration information of each vehicle will be synthesized, and thus the optimal matching relationship between each software group and each vehicle number, departure time of each vehicle, traveling roads, and whether the testing is performed in the outward trip (such as a trip from a starting point A to a ending point B) and the return trip (such as a trip from a ending point B to a starting point A) is synthesized and determined, as shown in the following table.

| | | | Traveling | | |
|---|---|---|---|---|---|
| Software group | Vehicle | Number of | road | Outward | Return |
| name | number | departures | number | trip | trip |
| First software | 1 | 2 | 1 | ✓ | ✓ |
| group 1 | | | | | |
| Second | 2 | 1 | 2 | X | ✓ |
| software group | | | | | |
| 2 | | | | | |
| Third software | 3 | 3 | 4 | ✓ | X |
| group 3 | | | | | |

In actual operation, before the test is started every day or every week, a remote device sends a test plan of each vehicle and a software group to be tested to a corresponding vehicle, and the corresponding vehicle loads the corresponding software group for testing according to the planned test project before each departure.

It can be seen that, according to the software version management and iteration solution provided in the present disclosure, the test frequency, the incorporation specification and the promotion rule of the images of different levels are set, such that the function codes of any developer can be tested step by step in a process of continuously improving the stability; meanwhile, the new codes can be used to start a new real vehicle test at any time based on the codes that have reached a certain stability, and the new test does not need to be waited for the completion of the previous whole test period. Since the relationship between the test quantity of real vehicles and the stability and the requirements on the test frequency of real vehicles in software development are simultaneously considered in the process, and the uniqueness of a code research and development iteration route (software functional test-candidate version integration test-pre-stable version integration test-stable version integration test) is ensured, the balance among the test number of real vehicles, the timeliness of new functional test arrangement of real vehicles and the code stability is realized, and thus the requirements of multiple parties on the real vehicle test and function development processes can be simultaneously met. In the present disclosure, the waste of test resources is reduced as much as possible, and meanwhile, the iteration speed of the software is ensured as much as possible, without excessively reducing the software research and development efficiency.

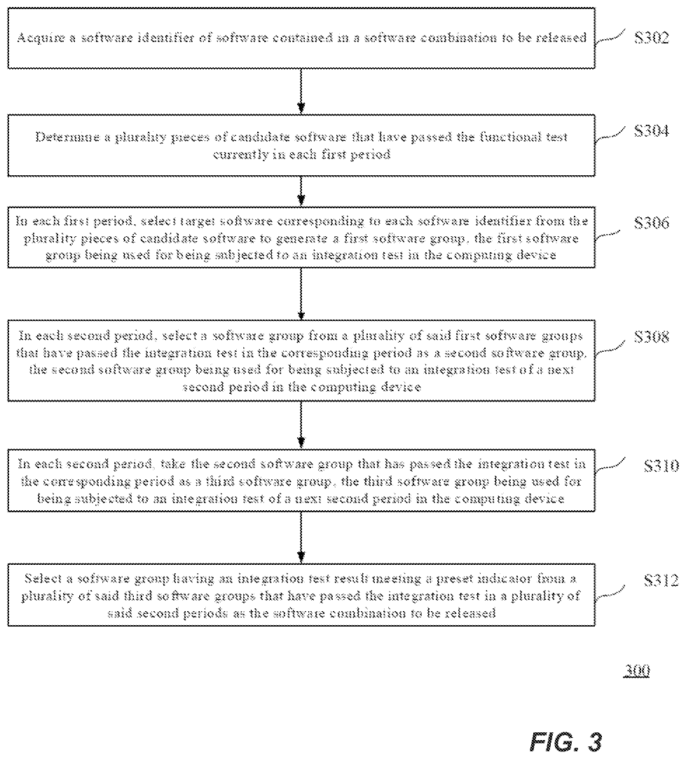

FIG. 3 is a flowchart of a software releasing method 300 according to another embodiment of the present disclosure. As shown in FIG. 3, the method 300 comprises:
Step S302: acquiring a software identifier contained in a software combination to be released;
Step S304: determining a plurality of candidate software that have passed the functional test currently in each first period;
Step S306: in each first period, selecting a target software for each software identifier from the plurality of candidate software to generate a first software group, the first software group to be subjected to an integration test in the computing device;
Step S308: in each second period, selecting at least one software group from a plurality of said first software groups that have passed the integration test in the corresponding period as a second software group, the second software group to be subjected to an integration test of a next second period in the computing device;
Step S310: in each second period, taking the second software group that has passed the integration test in the corresponding period as a third software group, the third software group to be subjected to an integration test of a next second period in the computing device; and
Step S312: selecting a software group having an integration test result meeting a preset indicator from a plurality of said third software groups that have passed the integration test in a plurality of said second periods as the software combination to be released.

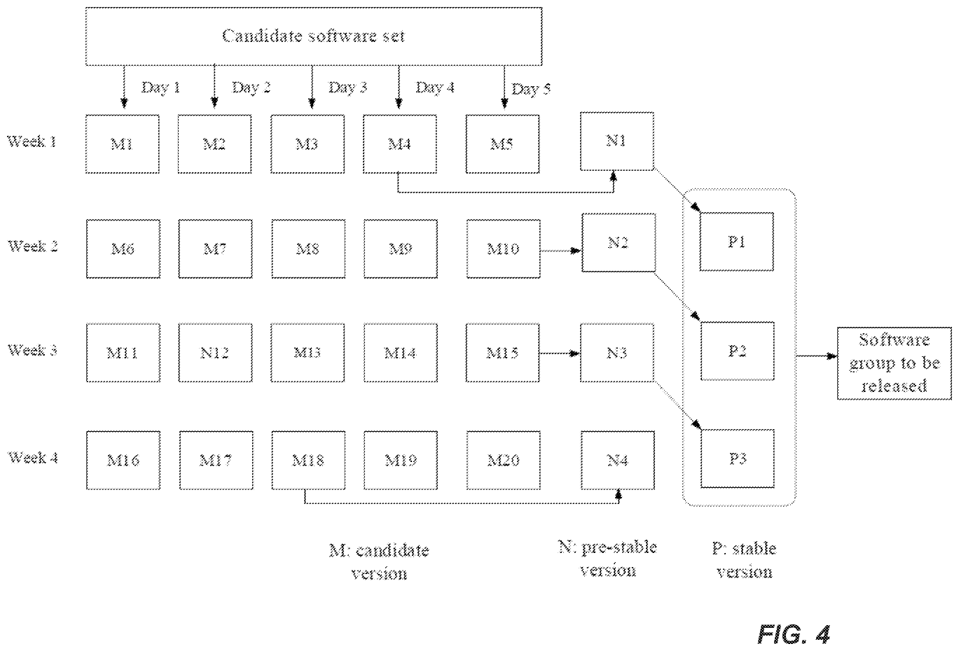

The flowchart in FIG. 3 can be understood by referring to the schematic diagram of software releasing in FIG. 4, where FIG. 4 takes a first period as one day and a second period as one week, and pieces of candidate software that have passed the functional test in every week constitute a candidate software set, the candidate software set is subjected to continuous iteration updates, and there may be a plurality of software versions in one piece of software.

In the first week, a first software group is generated based on the candidate software set every day, first software group M1 (i.e., candidate version 1) is generated on the first day, first software group M2 (i.e., candidate version 2) is generated on the second day, first software group M3 (i.e., candidate version 3) is generated on the third day, and so on. Each generated first software group will be subjected to the integration test, and if only the software groups are generated on weekdays in a week, 5 first software groups are subjected to the integration test in the week, and first software group M4 that has passed the integration test and has the latest version is selected therefrom and updated to second software group N1 (namely, pre-stable version 1).

In the second week, five new first software groups, M6-M10 (i.e., candidate versions 6-10) are generated. After the five first software groups are subjected to the one-week integration test, first software group M10 may be selected to be updated to second software group N2 (i.e., pre-stable version 2). Meanwhile, second software group N1 obtained in the first week is subjected to the integration test in the second week, and if it passes the integration test, second software group N1 is updated to third software group P1 (i.e., stable version 1).

In the third week, five new first software groups, M11-M15 (i.e., candidate versions 11-15), are generated. After the five first software groups are subjected to the one-week integration test, first software group M15 may be selected to be updated to second software group N3 (i.e., pre-stable version 3). Meanwhile, second software group N2 generated in the second week is subjected to the integration test in the third week, and if it passes the integration test, second software group N2 is updated to third software group P2 (i.e., stable version 2).

By analogy, new first software groups M16-M20 are generated in the fourth week, and after the five first software groups are subjected to the one-week integration test, first software group M18 is updated to second software group N4 (i.e., pre-stable version 4). Meanwhile, second software group N3 generated in the third week is updated to third software group P3 (i.e., stable version 2) after passing the integration test in the fourth week.

A plurality of third software groups may be subjected to the integration test in a plurality of continuous weeks, and the latest software group that has passed the integration test and hays an integration test result meeting the preset indicator is used as the software combination to be released. Here, the third software group is already a software combination having a stable version, and therefore the software group is regarded as the software group to be released only when the integration test result of the third software group meets a preset indicator. Once the software group to be released is determined, it cannot be changed easily, and when the test result of a new third software group is superior to that of the current software group to be released, the software group will be updated to a new third software group.

In addition, for ease of distinction, the methods 200 and 300 of the present disclosure are performed in a first computing device that may be a cloud device or a developer's computer, while the computing device used for the integration test performed on software groups may be referred to as a second computing device that is disposed on a vehicle. In an implementation, each software group may be generated or determined by the first computing device, an associative relationship table between the software groups and the test resources is generated. The software group to be tested and the test plan are sent to the second computing device on the corresponding vehicle according to the associative relationship table, such that each vehicle runs the corresponding software group every time during its departure. The test result of the software group on the vehicle is directly transmitted back to the first computing device, such that the first computing device can analyze whether the test result is normal, problematic software possibly generated in the problematic software group, problem codes possibly generated in the problematic software, etc.

According to the technical solution of the present application, one of a plurality of candidate version software groups which are generated and participate in the integration test is selected to be updated to a pre-stable software group in each second period, the pre-stable software group that has passed the integration test in the next second period is updated to a stable software group, and the stable software group meeting the preset indicator in the subsequent integration test is updated to a software group to be released, so that in the case that test resources such as the number of autonomous vehicles, the number of departures, the departure trip and the like are limited, the optimal matching solution between the software group to be tested and each test resource is reasonably generated, and each vehicle can test the software group in the traveling process according to the solution. Therefore, the efficiency for autonomous driving tests is improved, and the update test requirements of software releasing are met.

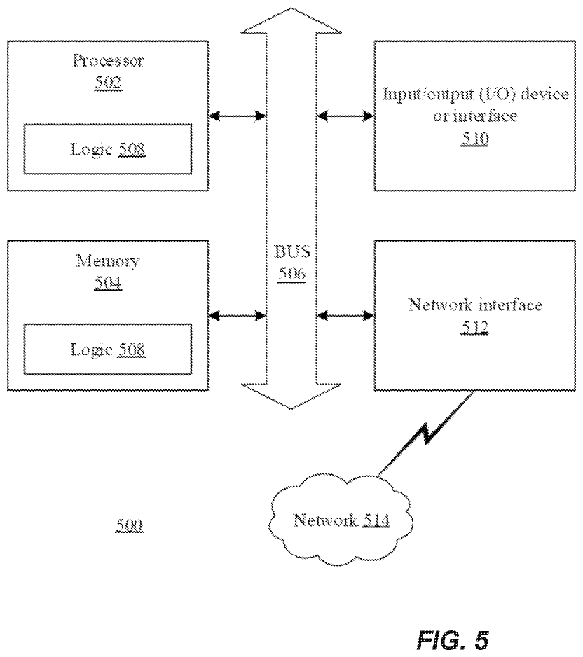

FIG. 5 illustrates a schematic of a machine in the example form of a computing device 500 in which an instruction set, when executed, and/or a processing logic, when initiated, may cause the machine to implement any one or more of the methods described and/or claimed herein. In alternative embodiments, the machine operates as a standalone device or may be connected (e.g., networked) to other machines. In a networked deployment, the machine may operate in the identity of either a server or a client machine in server-client network environments, or as a peer machine in peer-to-peer (or distributed) network environments. The machine may be a personal computer (PC), a laptop computer, a tablet computing system, a personal digital assistant (PDA), a cellular phone, a smartphone, a network application, a set-top box (STB), a network router, a switch or bridge, or any machine capable of executing the instruction set (sequentially or otherwise) that specify actions to be taken by that machine or initiating the processing logic. Further, although only a single machine is illustrated, the term “machine” may also be understood to encompass any combination of machines that individually or jointly execute an instruction set (or a plurality of instruction sets) to perform any one or more of the methods described and/or claimed herein.

The exemplary computing device 500 may comprise a data processor 502 (e.g., a System on Chip (SoC), a general-purpose processing core, a graphics core, and other optional processing logic) and a memory 504 (e.g., storage) that may communicate with each other via a bus 506 or other data transfer system. The computing device 500 may also comprise various input/output (I/O) devices and/or interfaces 510, such as a touch-screen display, an audio jack, a voice interface, and an optional network interface 512. In exemplary embodiments, the network interface 512 may comprise one or more radio transceivers configured for use with any one or more standard wireless and/or cellular protocols or access technologies (e.g., second generation (2G), 2.5 generation, third generation (3G), fourth generation (4G), and next-generation radio access of cellular systems, Global System for Mobile Communications (GSM), General Packet Radio Service (GPRS), Enhanced Data GSM Environment (EDGE), Wideband Code Division Multiple Access (WCDMA), LTE, CDMA2000, WLAN, Wireless Router (WR) mesh and the like). The network interface 512 may also be configured for use with various other wired and/or wireless communication protocols (including TCP/IP, UDP, SIP, SMS, RTP, WAP, CDMA, TDMA, UMTS, UWB, WiFi, WiMax, Bluetooth©, IEEE802.11x and the like). In essence, the network interface 812 may virtually comprise or support any wired and/or wireless communication and data processing mechanism by which information/data may be propagated between the computing device 500 and another computing or communication system via network 514.

The memory 504 may represent a machine-readable medium (or computer-readable storage medium) on which one or more instruction sets, software, firmwares, or other processing logics (e.g., logic 508) for performing any one or more of the methods or functions described and/or claimed herein are stored. The logic 508 or a portion thereof, when executed by the computing device 500, may also completely or at least partially reside in the processor 502. Therefore, the memory 504 and the processor 502 may also constitute the machine-readable medium (or computer-readable storage medium). The logic 508 or the portion thereof may also be configured as a processing logic or a logic, of which at least a portion is partially implemented in hardware. The logic 508 or the portion thereof may also be transmitted or received through the network 514 via the network interface 512. Although the machine-readable medium (or computer-readable storage medium) of the exemplary embodiments may be a single medium, the term “machine-readable medium” (or computer-readable storage medium) may be understood to comprise a single non-transitory medium or multiple non-transitory media (e.g., a centralized or distributed database, and/or an associated cache and computing system) that store one or more instruction sets. The term “machine-readable medium” (or computer-readable storage medium) may also be understood to comprise any non-transitory medium that is capable of storing, encoding or carrying an instruction set for execution by the machine and that cause the machine to perform any one or more of the methods of the various embodiments or that is capable of storing, encoding or carrying data structures utilized by or associated with such an instruction set. The term “machine-readable medium” (or computer-readable storage medium) may accordingly be understood to comprise, but not be limited to, solid-state memories, optical media, and magnetic media.

The disclosed and other embodiments, modules, and functional operations described herein may be implemented in digital electronic circuitry, or in computer software, firmware or hardware (including the structures disclosed herein and structural equivalents thereof), or in combinations of one or more. The disclosed and other embodiments may be implemented as one or more computer program products, that is, one or more modules of computer program instructions encoded on a computer-readable medium for execution by, or control of the operation of, data processing apparatus. The computer-readable medium may be a machine-readable storage device, a machine-readable storage substrate, a memory device, a composition of matter impacting machine-readable propagated signals, or a combination of one or more. The term “data processing apparatus” encompasses all apparatus, devices, and machines for processing data, including, for example, a programmable processor, a computer, or multiple processors or computers. In addition to hardware, the apparatus may further comprise codes that create an execution environment for the computer program in question, e.g., codes that constitute processor firmware, a protocol stack, a database management system, an operating system, or a combination of one or more. A propagated signal is an artificially generated signal (e.g., a machine-generated electrical, optical, or electromagnetic signal) that is generated to encode information for transmission to suitable receiver apparatus.

A computer program (also referred to as a program, software, a software application, a script, or a code) may be written in any form of programming language (including compiled languages or interpreted languages), and the computer program may be deployed in any form, including as an independent program or as a module, a component, a subroutine, or another unit suitable for use in a computing environment. A computer program does not necessarily correspond to a file in a file system. A program can be stored in a portion of a file that holds other programs or data (e.g., one or more scripts stored in a markup language document), stored in a single file dedicated to the program in question, or stored in multiple collaborative files (e.g., files that store one or more modules, sub programs, or portions of code). A computer program may be deployed for execution on one computer or on multiple computers that are located at one site or distributed across multiple sites and interconnected by a communication network.

The processes and logic flows described herein may be executed by one or more programmable processors executing one or more computer programs to perform functions by operating on input data and generating output. The processes and logic flows may also be executed by, and the apparatus may also be implemented as, a special purpose logic circuitry (e.g., an FPGA (field-programmable gate array) or an ASIC (application-specific integrated circuit)).

Processors suitable for executing a computer program comprise, for example, both general-purpose microprocessors and special purpose microprocessors, and any one or more processors of any kind of digital computer. Generally, a processor will receive instructions and data from a read-only memory or a random access memory or both. The necessary elements of a computer are a processor for executing instructions and one or more memory devices for storing instructions and data. Generally, a computer may also comprise one or more mass-storage devices for storing data (e.g., magnetic disks, magneto-optical disks, or optical disks), or the computer may also be operatively coupled to receive data from or transfer data to the one or more mass-storage devices, or both. However, the computer does not necessarily have such devices. Computer-readable media suitable for storing computer program instructions and data comprise all forms of non-volatile memory, media and memory devices, including, e.g., semiconductor memory devices (e.g., EPROM, EEPROM, and a flash memory device), magnetic disks (e.g., an internal hard disk or a removable disk), magneto-optical disks, and CD-ROM disks and DVD-ROM disks. The processor and the memory can be supplemented by, or incorporated in, the special purpose logic circuitry system.

Although the present application contains many details, these should not be construed as limitations on the scope of any invention or of what may be claimed, but rather as descriptions of features specific to particular embodiments of particular inventions. Certain features that are described herein in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially required, one or more features from a required combination may in some cases be excised from the combination, and the required combination may be directed to a subcombination or variation of a subcombination.

Similarly, although operations are depicted in the drawings in a particular order, this should not be understood as requiring that such operations be executed in a particular order shown or in a sequential order, or that all illustrated operations be executed, to achieve desirable results. Moreover, the separation of various system components in the embodiments described herein should not be understood as requiring such separation in all embodiments.

Only some implementations and examples are described and other implementations, enhancements and changes may be made based on what is described and illustrated herein.

The illustrations of embodiments described herein are intended to provide a general understanding of the structure of various embodiments, and they are not intended to serve as a complete description of all of the elements and features of components and systems that may utilize the structures described herein. Many other embodiments will be apparent to those of ordinary skill in the art upon reviewing the description provided herein. Other embodiments may be utilized and derived, such that structural and logical replacements and changes may be made without departing from the scope of the present application. The drawings herein are merely representational and may not be drawn to scale. Certain proportions may be exaggerated, while other proportions may be minimized. Accordingly, the specification and drawings are to be regarded as illustrative rather than restrictive.

Some embodiments implement functions in two or more particular interconnected hardware modules or devices with related control and data signals conveyed among and through modules, or as portions of an application-specific integrated circuit. Accordingly, the exemplary systems are applicable to software, firmware, and hardware implementations.

Although exemplary embodiments or examples of the present application have been described with reference to the accompanying drawings, it should be understood that the above exemplary discussion is not intended to be exhaustive or to limit the present invention to the precise forms disclosed. Many modifications and variations are possible in view of the above teachings. Therefore, the disclosed subject matter should not be limited to any single embodiment or example described herein, but rather should be construed in breadth and scope in accordance with the appended claims.

What is claimed is:

1. A software releasing method, comprising:
acquiring a software identifier for each software contained in a software combination;
in each first period, selecting a target software for each software identifier from a plurality of candidate software that have passed a functional test to generate a first software group to be subjected to an integration test in a computing device;
in each second period, selecting at least one software group from the first software groups that have passed the integration test as a second software group to be subjected to the integration test of a next second period in the computing device; and
in each second period, selecting at least one software group from the second software groups that have passed the integration test as the software combination to be released.

2. The method according to claim 1, wherein the functional test is used for testing whether the software is normal, and the integration test is used for testing whether the software groups are normal.

3. The method according to claim 1, wherein, selecting at least one software group from the second software groups that have passed the integration test as the software combination to be released comprises:
taking the second software group that has passed the integration test as a third software group to be subjected to the integration test of a next second period in the computing device; and
selecting a software group having an integration test result meeting a preset indicator from the third software groups that have passed the integration test as the software combination to be released.

4. The method according to claim 3, further comprising:
determining problematic software groups that have not passed the integration test, from at least one of the first software groups, the second software groups or the third software groups;
determining problematic software and normal software of each problematic software group;
updating codes of each problematic software;
generating a fourth software group to be subjected to an integration test in the computing device based on the updated codes of the problematic software, and the normal software of the problematic software groups; and
updating, in response to the fourth software group passing the integration test in the computing device, the problematic software groups with the fourth software group.

5. The method according to claim 3, further comprising:
updating a to-be-tested software—in the software combination into the third software group of a current second period to obtain a fifth software group to be subjected to an integration test in the computing device; and
determining, in response to the fifth software group passing the integration test in the computing device, that the to-be-tested software passes the functional test.

6. The method according to claim 5, wherein updating a to-be-tested software in the software combination into the third software group of the current period comprises at least one of the following:
adding, in response to the third software group of the current second period not containing legacy version of the to-be-tested software to be tested, the to-be-tested software into the third software group; and
replacing, in response to the third software group of the current second period containing legacy version of the software to be tested, the legacy version with the to-be-tested software.

7. The method according to claim 5, wherein
the computing device comprises a plurality of computing devices disposed on a plurality of vehicles;
the first to fifth software groups in each second period are tested in the plurality of computing devices of the plurality of vehicles.

8. The method according to claim 7, wherein the vehicle is an autonomous vehicle, the software in the software combination is autonomous driving software, and the preset indicator is a safety stability indicator for autonomous driving and comprises at least one of a number of manual takeovers per kilometer, a number of system errors per unit time, a time occupancy of a high occupancy of system resources, and a mean occupancy of the system resources.

9. The method according to claim 7, further comprising:
determining a plurality of test trips of the plurality of vehicles in a preset period; and
establishing an associative relationship between the software groups to be tested and the vehicles and the test trips, so as to test the associated software group in the test trip of each vehicle.

10. The method according to claim 9, wherein the test trip comprises an outward trip and a return trip, the outward trip and the return trip being used for testing different software groups, or the outward trip and the return trip being used for testing the same software group.

11. The method according to claim 10, wherein the vehicle associated with each software group to be tested meet a test environment requirement of the software group to be tested.

12. The method according to claim 1, wherein the software comprises at least one of:
container files, binary software packages, and compressed packages with file names, and the software has at least one of a formal version and a test version.

13. The method according to claim 1, wherein:
each type of the first software group, second software group and third software group has a corresponding software group label, each software group has a corresponding software group identifier, and the selected software group comprise the software group that has passed the integration test and has a latest version;
the software group labels comprise at least one of a candidate version, a pre-stable version, a stable version, and a pre-release version;
the first software group is of a candidate version, the second software group is of a pre-stable version, and the third software group is of a stable version.

14. A computing device, comprising:
a processor, a memory, and a computer program stored on the memory and executable on the processor;
wherein the processor, when executing the computer program, performs method comprising:
acquiring a software identifier for each software contained in a software combination;
in each first period, selecting a target software for each software identifier from a plurality of candidate software that have passed a functional test to generate a first software group to be subjected to an integration test in a computing device;
in each second period, selecting at least one software group from the first software groups that have passed the integration test as a second software group to be subjected to the integration test of a next second period in the computing device; and
in each second period, selecting at least one software group from the second software groups that have passed the integration test as the software combination to be released.

15. The computing device according to claim 14, wherein selecting at least one software group from the second software groups that have passed the integration test as the software combination to be released comprises:
taking the second software group that has passed the integration test as a third software group, the third software group to be subjected to the integration test of a next second period in the computing device; and
selecting a software group having an integration test result meeting a preset indicator from the third software groups that have passed the integration test as the software combination to be released.

16. The computing device according to claim 15, wherein the method further comprises:
determining problematic software groups that have not passed the integration test, from at least one of the first software groups, the second software groups or the third software groups;
determining problematic software and normal software of each problematic software group; and
updating codes of each problematic software;
generating a fourth software group to be subjected to an integration test in the computing device based on the updated codes of the problematic software, and the normal software of the problematic software groups; and
updating, in response to the fourth software group passing the integration test in the computing device, the problematic software groups with the fourth software group.

17. The computing device according to claim 15, wherein the method further comprises:
updating a to-be-tested software in the software combination into the third software group of a current second period to obtain a fifth software group to be subjected to an integration test in the computing device; and
determining, in response to the fifth software group passing the integration test in the computing device, that the to-be-tested software passes the functional test;
wherein updating the to-be-tested software into the third software group of the current period comprises at least one of the following:
adding, in response to the third software group of the current second period not containing legacy version of the to-be-tested software, the to-be-tested software into the third software group; and
replacing, in response to the third software group of the current second period containing legacy version of the software to be tested, the legacy version with the to-be-tested software.

18. A non-transitory computer-readable storage medium having a computer program stored thereon, wherein the computer program, when executed by a processor, causes the computing device to implement a method comprising:
acquiring a software identifier for each software contained in a software combination;
in each first period, selecting a target software for each software identifier from a plurality of candidate software that have passed a functional test to generate a first software group to be subjected to an integration test in a computing device;
in each second period, selecting at least one software group from the first software groups that have passed the integration test as a second software group to be subjected to the integration test of a next second period in the computing device; and
in each second period, selecting at least one software group from the second software groups that have passed the integration test as the software combination to be released.

19. The non-transitory computer-readable storage medium according to claim 18, wherein
the computing device comprises a plurality of computing devices disposed on a plurality of vehicles;
each software group in each second period respectively is tested in the plurality of computing devices of the plurality of vehicles.

20. The non-transitory computer-readable storage medium according to claim 19, wherein the method further comprises:
determining a plurality of test trips of the plurality of vehicles in a preset period; and establishing an associative relationship between the software groups to be tested and the vehicles and the test trips, so as to test the associated software group in the test trip of each vehicle;
wherein the test trip comprises an outward trip and a return trip, the outward trip and the return trip being used for testing different software groups, or the outward trip and the return trip being used for testing the same software group.
